(19) United States
(12) Patent Application Publication
(10) Pub. No.: US 2015/0378443 A1
(43) Pub. Date: Dec. 31, 2015

(54) INPUT FOR PORTABLE COMPUTING DEVICE BASED ON PREDICTED INPUT

(71) Applicant: HEWLETT-PACKARD DEVELOPMENT COMPANY, L.P., Houston, TX (US)

(72) Inventor: Yang Luo, Shanghai (CN)

(21) Appl. No.: 14/766,813

(22) PCT Filed: Feb. 28, 2013
(86) PCT No.: PCT/CN2013/072026

§ 371 Date: Aug. 10, 2015

(51) Int. Cl. G06F 3/01; G06F 3/0484; G06F 3/0488; G06F 3/041; G06F 3/03

(52) U.S. Cl. CPC G06F 3/017; G06F 3/0416; G06F 3/0304; G06F 3/04886; G06F 3/04842

(57) ABSTRACT

A portable computing device to detect a first panel of the portable computing device for a hand gesture and to display at least one predicted input at a second panel of the portable computing device based on the hand gesture. The portable computing device receives an input in response to a user selecting a predicted input at the second panel.

### BACKGROUND

When a user would like to enter one or more commands into a computing device, the user can access an input component, such as a keyboard and/or a mouse of the computing device. The user can use the keyboard and/or mouse to enter one or more inputs for the computing device to interpret. The computing device can proceed to identify and execute a command corresponding to the input received from the keyboard and/or the mouse.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1A and FIG. 1B illustrate examples of a portable computing device with a sensor to detect a hand gesture and panels of the portable computing device.

FIGS. 2A and 2B illustrate an example of a portable computing device to detect a hand gesture at a first panel and to detect an input selected at a second panel.

FIG. 3 illustrates an example of a block diagram of an input application predicting inputs based on a hand gesture and detecting an input for the portable computing device based on the predicting inputs.

FIG. 4 is an example flow chart illustrating a method for detecting an input.

FIG. 5 is another example flow chart illustrating a method for detecting an input.

### DETAILED DESCRIPTION

A portable computing device includes a first panel and a second panel. In one implementation the first panel includes a rear panel of the portable computing device and the second panel includes a front panel of the portable computing device. The portable computing device includes a sensor, such as a touch surface, a touchpad, an image capture component, and/or a proximity sensor to detect for a hand gesture at the first panel of the portable computing device. The hand gesture includes a user touching or repositioning the user's finger(s) or palm at the rear panel of the portable computing device. In one implementation, locations at the first panel correspond to locations of a virtual keyboard of the portable computing device.

In response to the sensor detecting a hand gesture from the user, the portable computing device predicts at least one input for the portable computing device based on the hand gesture. For the purposes of this application, a predicted input includes an input which is anticipated by the portable computing device based on information detected from the hand gesture. The detected information includes a portion of recognized information utilized by the portable computing device to identify an input for the portable computing device. In one implementation, if the detected information from the hand gesture corresponds to one or more alphanumeric characters of a virtual keyboard, one or more predicted inputs for the portable computing device include words which match, begin with, end with and/or contain the alphanumeric characters. For example, if the detected information from the hand gesture is the alphanumeric characters “rob,” the predicted inputs can include “Rob,” “Robert,” “robbery,” and “probe.”

In response to the portable computing device identifying at least one predicted input, a display component, such as a touch screen displays the predicted inputs for a user to select. The display component is included at the second panel of the portable computing device. If the user accesses the touch screen to select one of the predicted inputs, the predicted input is received by the portable computing device as an input for the portable computing device. As a result, an amount of accidental inputs for the portable computing device can be reduced by predicting inputs for the portable computing device based on a hand gesture detected at a rear panel and displaying the predicted inputs at a front panel for the user to select.

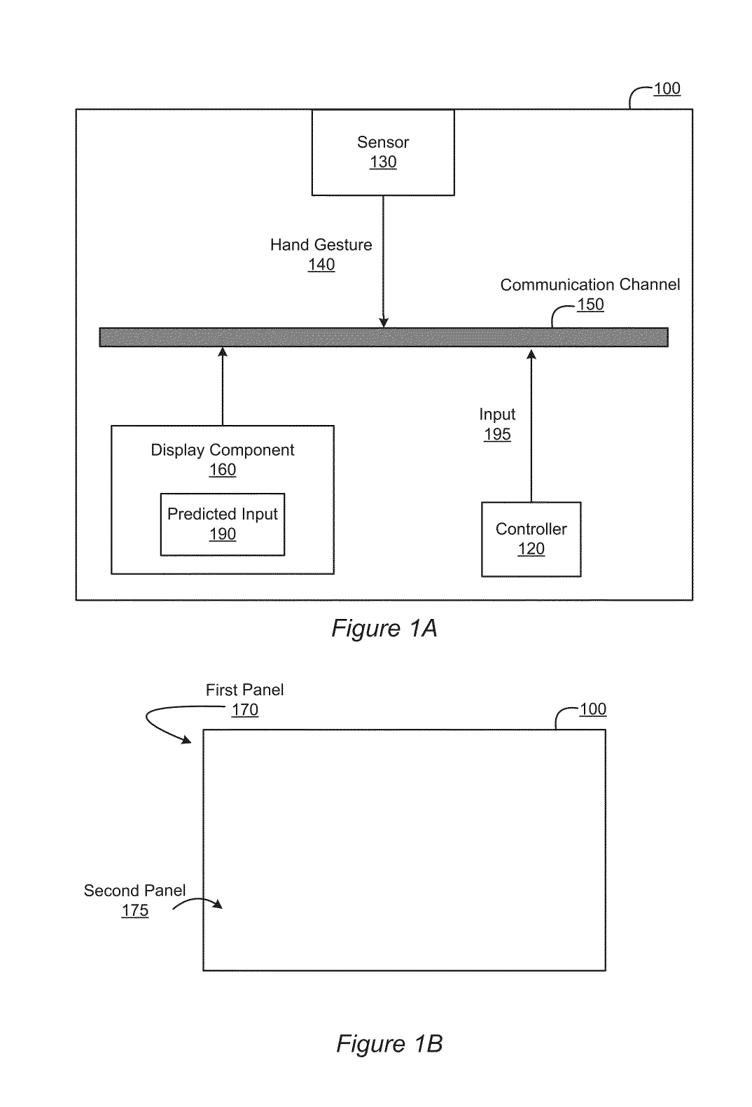

FIG. 1A and FIG. 1B illustrate a portable computing device 100 with a sensor 130 to detect a hand gesture 140 and panels 170, 175 of the portable computing device 100 according to an example. The portable computing device 100 can be a tablet, a smart phone, a cellular device, a PDA (personal digital assistance), an AIO (all-in-one) computing device, a notebook, a convertible or hybrid notebook, a netbook, and/or any additional portable computing device 100 with a sensor 130 to detect for a hand gesture 140.

As shown in FIG. 1A, the portable computing device 100 includes a controller 120, a sensor 130, a display component 160, and a communication channel 150 for the controller 120 and/or one or more components of the portable computing device 100 to communicate with one another. In one implementation, the portable computing device 100 also includes an input application stored on a non-volatile computer readable medium included in or accessible to the portable computing device 100. For the purposes of this application, the input application is an application which can be utilized independently and/or in conjunction with the controller 120 to detect inputs 195 for the portable computing device 100.

As shown in FIG. 1B, the portable computing device 100 includes a first panel 170 and a second panel 175. The first panel 170 can be a rear panel of the portable computing device 100. The rear panel includes a rear frame, a rear panel, an enclosure, a casing, and/or a docking component for the portable computing device 100. The second panel 175 can be a front panel of the portable computing device 100. The second panel 175 includes a front frame, a front panel, an enclosure, and/or a casing for the portable computing device 100. In another implementation, the second panel 175 can include a side panel of the portable computing device 100.

A sensor 130 of the portable computing device 100 is used to detect for a hand gesture by detecting for finger(s) or a palm of a user at the first panel 170. The user can be any person which can enter inputs for the portable computing device 100 by accessing the first panel 170. For the purposes of this application, the sensor 130 is a hardware component of the portable computing device 100, such as a touch surface, a touchpad, an image capture component, a proximity sensor and/or any additional device which can detect for a hand of the user at the first panel of the portable computing device 100.

The sensor 130 detects for finger(s) and/or a palm of the user touching or within proximity of the first panel 170. If the sensor 130 detects a hand gesture 140 at the first panel, the controller 120 and/or the input application receive information of the hand gesture 140. The information of the hand gesture 140 can include coordinates of the first panel 170 accessed by the hand gesture 140. In one implementation, the information also includes whether the hand gesture 140 includes a finger or palm reposition, a number of fingers used in the hand gesture 140, and/or an amount of pressure used by the hand gesture 140.

The controller 120 and/or the input application use the detected information of the hand gesture 140 to predict one or more inputs 195 for the portable computing device 100. For the purposes of this application, a predicted input 190 includes an input 195 for the portable computing device 100 which is anticipated by the controller 120 and/or the input application based on the detected information from the hand gesture 140. For the purposes of this application, an input is anticipated by the controller 120 and/or the input application if the detected information from the hand gesture matches a portion or all of the recognized information corresponding to an input 195 for the portable computing device 100.

In one example, a predicted input 190 for the portable computing device 100 is an input 195 for alphanumeric character(s) for the portable computing device 100. In another example, the predicted input 190 can be an input 195 to select content of the portable computing device 100, an input 195 to launch content of the portable computing device 100, an input 195 to launch a menu for content, an input 195 to navigate content or the portable computing device 100, and/or an input 195 to switch between modes of operation of the portable computing device 100.

When identifying a predicted input 190, the controller 120 and/or the input application compare the detected information from the hand gesture 140 to recognized information corresponding to an input. If the detected information includes all or a portion of the recognized information corresponding to an input, the corresponding input will be identified by the controller 120 and/or the input application as a predicted input 190 for the portable computing device 100.

In one implementation, the controller 120 and/or the input application access a table, database, and/or list of inputs. The table, database, and/or list of inputs can be local or remote to the portable computing device 100 and include recognized inputs for the portable computing device 100 and their corresponding information. The controller 120 and/or the input application determine if the detected information from the hand gesture 140 matches a portion of corresponding information of any of the recognized inputs. If the detected information matches a portion of corresponding information for any of the recognized inputs, the recognized input will be identified as a predicted input 190.

In one example, the detected information from the hand gesture 140 includes accessed coordinates corresponding to a virtual keyboard with alphanumeric characters “ham.” The controller 120 and/or the input application compare the detected information to information of recognized inputs and determine that “ham” is a portion of the words “sham,” “hamburger,” and “ham.” In response, “sham, “hamburger,” and “ham” are identified to be predicted inputs 190 based on the hand gesture 140.

In another implementation, the detected information from the hand gesture 140 does not correspond to locations of a virtual keyboard. The detected information specifies the hand gesture 140 is repositioning from Left-to-Right. The controller 120 and/or the input application compare the detected information to information of recognized inputs and determines that recognized inputs 1) “navigate next” includes information specifying for a hand gesture to reposition from Left-to-Right and 2) “bring up menu” includes information specifying for a hand gesture to reposition Up First and then Left-to-Right. In response, the controller 120 and/or the input application identify the “navigate next” and “bring up menu” as predicted inputs 190.

In response to identifying one or more predicted inputs 190, the controller 120 and/or the input application instruct a display component 160, such as a touch screen, to display the predicted inputs 190. The display component 160 is included at the second panel 175 of the portable computing device 100. The display component 160 can display the predicted inputs 190 at corner locations of the display component 160, within reach of a finger, such as a thumb, of the user. The corner locations can include a left edge, a right edge, a top edge, and/or a bottom edge of the display component 160.

If the display component 160 is a touch screen, the user selects one of the predicted inputs 190 by touching the corresponding predicted input 190 displayed on the touch screen. In other implementations, other sensors coupled to the second panel 175, such as a touch surface, a touchpad, an image capture component, and/or a proximity sensor can be used instead of a touch screen to detect for the user selecting a predicted input 190. In response to the user selecting one of the displayed predicted inputs 190, the controller 120 and/or the input application receive the selected predicted input 190 as an input 195 for the portable computing device 100. Receiving the input 190 can include the controller 120 and/or the input application executing the input 195 as a command for the portable computing device 100.

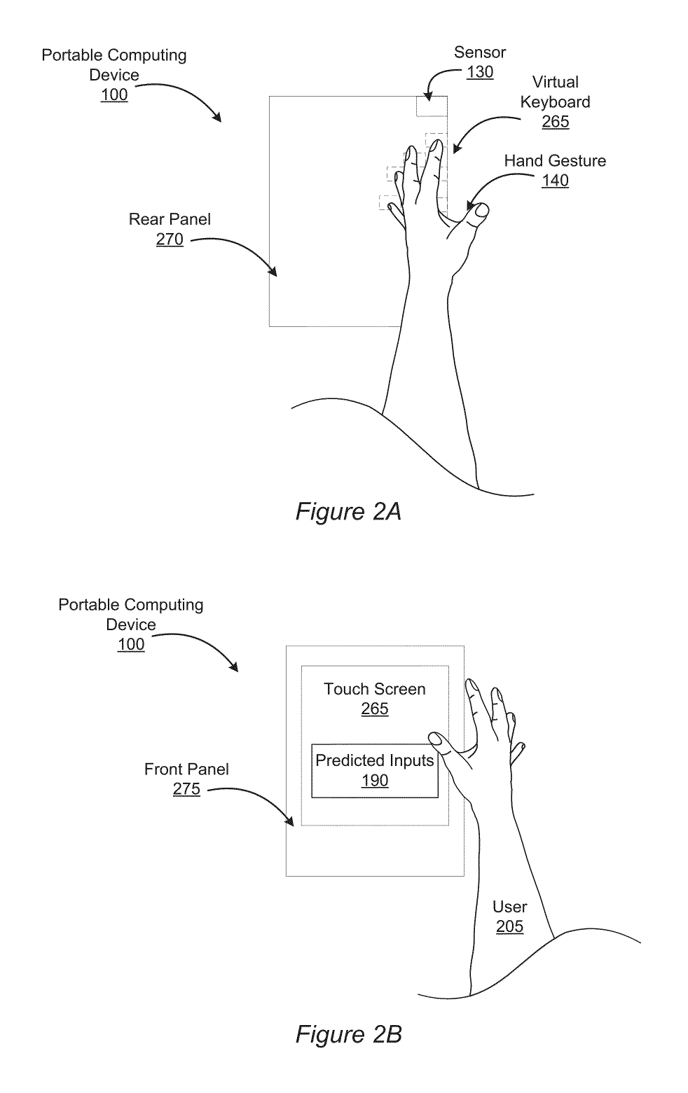

FIGS. 2A and 2B illustrate a portable computing device 100 to detect a hand gesture 140 at a first panel and to detect an input selected at a second panel according to an example. FIG. 2A illustrates a rear view of the portable computing device 100 and a rear panel 270 of the portable computing device 100. The rear panel 270 includes a rear frame, a rear panel, an enclosure, and/or a casing for the portable computing device 100. In another example, the rear panel 270 can be a removable docking component for the portable computing device 100.

As shown in FIG. 2A, a sensor 130, such as a touch surface, a touchpad, an image capture component, and/or a proximity sensor, can be coupled to the rear panel 270. The sensor 130 detects for a hand gesture 140 from a user 205 at the rear panel 270. In another implementation, the sensor 130 can include a first portion and a second portion. The first portion of the sensor 130 can be included at a front panel of the portable computing device and the second portion of the sensor 130 can be included at the rear panel 270 or vice versa. If the sensor 130 includes a first portion and a second portion, the second portion of the sensor 130 detects for the hand gesture 140 at the rear panel 270 and the second portion detects for the user selecting a predicted input 190 at the front panel 275.

The sensor 130 can detect for finger(s) and/or a palm of the user 205 touching or coming within proximity of the rear panel 270. When detecting the hand gesture 140, the sensor 130 detects coordinates of the rear panel 270 accessed by the hand gesture 140, a number of fingers used for the hand gesture 140, whether the hand gesture 140 is stationary or repositioning, and/or an amount of pressure used by the hand gesture 140. The sensor 130 passes detected information of the hand gesture 130 to a controller and/or an input application to identify one or more predicted inputs 190 for the portable computing device 100.

In one implementation, as shown in FIG. 2A, locations of the rear panel 270 correspond to locations of a virtual keyboard 265 for the portable computing device 100. As a result, the user 205 can access alphanumeric characters of the virtual keyboard 265 by touching or coming within proximity of locations of the rear panel 270 corresponding to the alphanumeric characters. In another implementation, not shown, the user 205 can use the rear panel 270 for other inputs for the portable computing device 100 not including a virtual keyboard 265, such as to make hand gestures 140 which include motion or repositioning for a navigation input of the portable computing device 100.

In one implementation, the sensor 130 can also detect for a second hand gesture at the rear panel 270. The second hand gesture can be made with a second hand of the user 205. The sensor 130 can detect for the second hand gesture in parallel with detecting for the first hand gesture 140. Similar to when detecting for the first hand gesture 140, the sensor 130 detects for finger(s) and/or a palm of the user 205 touching or coming within proximity of the rear panel 270 and pass detected information of the second hand gesture to the controller and/or the input application. If both a first hand gesture 140 and a second hand gesture are detected, the controller and/or the input application use detected information from both of the first and the second hand gestures when predicting inputs for the portable computing device 100.

FIG. 2B shows a front view of the portable computing device 100 and a front panel 275 of the portable computing device 100. The front panel 275 includes a display component 160 to display predicted inputs 190 for the portable computing device 100. The display component 160 can be a liquid crystal display, a cathode ray tube, and/or any additional output device to display the predicted inputs 190. In one implementation, the display component 160 is a touch screen. The touch screen can be integrated with, etched on, and/or a separate layer from the display component 160.

In one example, a predicted input 190 for the portable computing device 100 is an input 195 for alphanumeric character(s) for the portable computing device 100. In another implementation, the predicted input 190 can be an input 195 to select content of the portable computing device 100, an input 195 to launch content of the portable computing device 100, an input 195 to launch a menu for content, an input 195 to navigate content or the portable computing device 100, and/or an input 195 to switch between modes of operation of the portable computing device 100. The content can include a file, media, object and/or a website accessible to the portable computing device 100.

The predicted inputs 190 can be displayed as bars, buttons, icons, and/or objects on the display component 160. In one implementation, the predicts inputs 190 are displays at one or more corners of the display component 160 such that they are easily accessible to a finger of the user 205 holding the portable computing device 100. For example, the user 205 can use a thumb or index finger to select one of the predicted inputs 190 rendered at a corner of the display component 160.

If the display component 160 is a touch screen, the touch screen can detect for the user 205 selecting one of the predicted inputs 190 displayed on the touch screen. In another implementation, if the sensor 130 includes a first portion and a second portion, the first portion of the sensor 130 can detect for the user 205 selecting one of the predicts inputs 190. In other implementations, the portable computing device 100 can further include an input component (not shown) at the front panel 275 to detect for the user 205 navigating the predicted inputs 190 to select one of them. The input component can include one or more buttons and/or touch pad to navigate between predicted inputs 190 and to select a predicted input 190. In response to the user 205 selecting one of the predicted inputs, the controller and/or the input application can receive the predicted input 190 as an input 195 for the portable computing device 100.

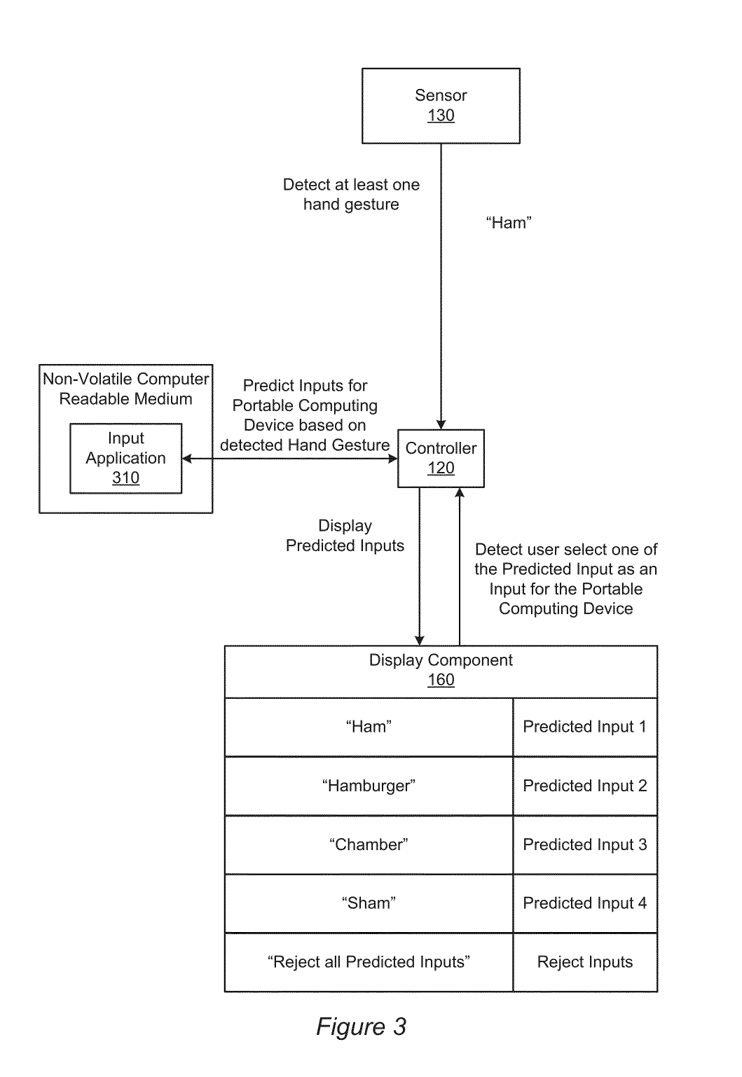

FIG. 3 illustrates an example of a block diagram of an input application 310 predicting inputs based on a hand gesture and detecting an input for the portable computing device based on the predicting inputs. As noted above, the input application 310 is utilized independently and/or in conjunction with the controller 120 to manage inputs for the portable computing device. In one embodiment, the input application 310 can be a firmware embedded onto one or more components of the computing device. In another embodiment, the input application 310 can be an application accessible from a non-volatile computer readable memory of the computing device. The computer readable memory is a tangible apparatus that contains, stores, communicates, or transports the input application 310 for use by or in connection with the computing device. The computer readable memory can be a hard drive, a compact disc, a flash disk, a network drive or any other tangible apparatus coupled to the computing device.

As shown in FIG. 3, the sensor 130 has detected a hand gesture at a first panel, such as a rear panel, of the portable computing device. The sensor 130 information of the hand gesture, including accessed locations of the rear panel to the controller 120 and/or the input application 310. The information of the accessed locations can be passed to the controller 120 and/or the input application 310 as coordinates of the rear panel. In one implementation, the accessed locations correspond to a virtual keyboard of the portable computing device. Each alphanumeric character of the virtual keyboard can include designated coordinates at the rear panel.

The controller 120 and/or the input application 310 compare the accessed coordinates at the rear panel to locations of the virtual keyboard to determine which alphanumeric character of the virtual keyboard have been accessed. As shown in FIG. 3, the controller 120 and/or the input application 310 determine that characters “H”, “a”, and “m” have been accessed by the user's hand gesture. The controller 120 and/or the input application 310 proceed to predict inputs for the portable computing device based on the detected hand gesture. In one implementation, when predicting inputs, the controller 120 and/or the input application 310 identify words or alphanumeric character strings which start with, end with, or contain the accessed characters. The controller 120 and/or the input application 310 can access a local or remote word bank, such as a dictionary or database to identify words containing the accessed characters.

As shown in FIG. 3, the controller 120 and/or the input application 310 identify “Ham,” “Hamburger,” “Chamber,” and “Sham” as predicted inputs for the portable computing device based on the inclusion of “H,” “a,” “m” in the words. In response to predicting one or more inputs, the controller 120 and/or the input application 310 render the predicted inputs on a display component 160, such as a touch screen, of the portable computing device. In one implementation, the controller 120 and/or the input application 310 also render an option to reject all of the predicted inputs. If the user selects one of the predicted inputs, the controller 120 and/or the input application 310 can receive the predicted input as an input for the portable computing device. If the user accesses the option to reject all inputs, the controller 120 and/or the input application can clear and remove all of the predicted inputs from display and the sensor 130 can continue to detect for the user accessing locations of the rear panel with a hand gesture.

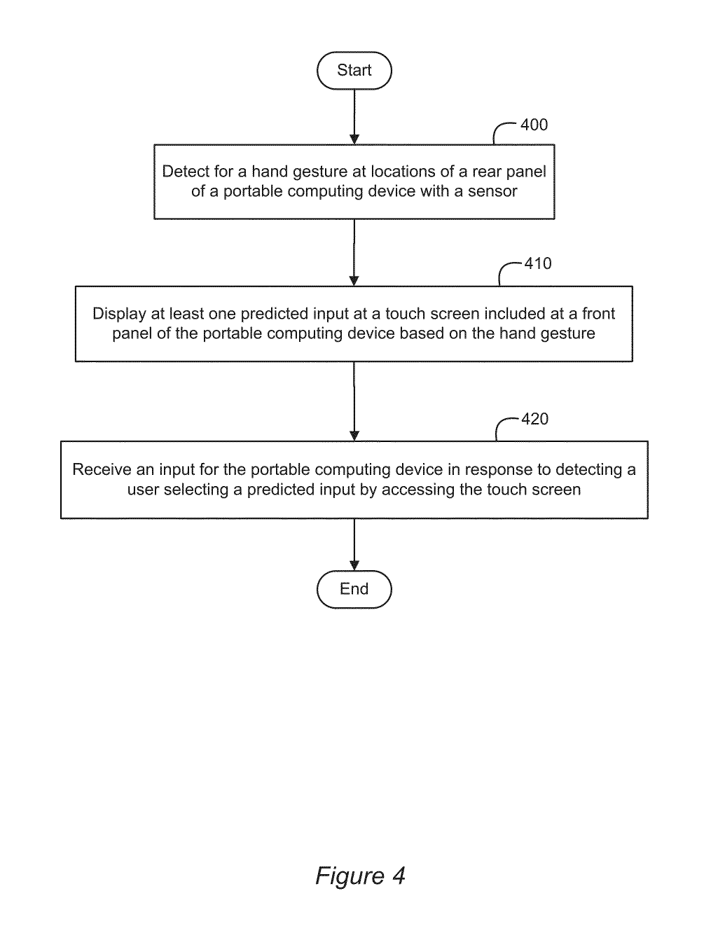

FIG. 4 is a flow chart illustrating a method for detecting an input according to an example. The sensor can initially detect for a hand gesture at locations of a rear panel of a portable device at 400. If a hand gesture is detected, a controller and/or an input application display at least one predicted input on a touch screen based on the hand gesture at 410. The touch screen is included at a front panel of the portable computing device. A user uses the touch screen to select one of the predicted inputs displayed on the touch panel for the controller and/or the input application to receive an input application for the portable computing device at 420. The method is then complete. In other embodiments, the method of FIG. 4 includes additional steps in addition to and/or in lieu of those depicted in FIG. 4.

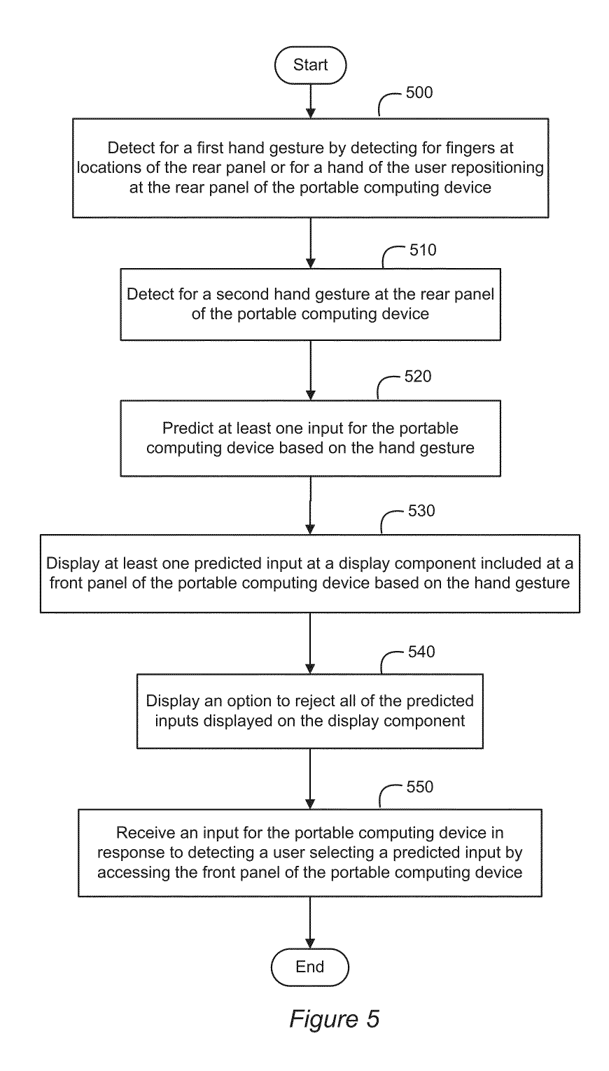

FIG. 5 is a flow chart illustrating a method for detecting an input according to an example. A sensor initially detects for a hand gesture by detecting for fingers at locations of the rear panel or for a hand of the user repositioning at the rear panel of the portable computing device at 500. The sensor can also detect for a second hand gesture at other locations of the rear panel by detecting for fingers or for a hand of the user repositioning at 510. In response to detecting a hand gesture, a controller and/or an input application can predict one or more inputs for the portable computing device at 520. In response to identifying one or more predicted inputs, the controller and/or the input application instruct a display component, such as a touch screen, to display the predicted inputs at 530. In one implementation, the touch screen can also display an option to reject all of the predicted inputs at 540.

If the touch screen detects the user select one of the predicted inputs, the controller and/or the input application proceed to receive an input for the portable computing device at 550. If a user selects the option to reject all of the predicted inputs, the controller and/or the input application can continue to identify one or more predicted inputs for the portable computing device in response to detecting one or more hand gestures at the rear panel of the portable computing device. In another implementation, additional sensor components, such as an image capture component, a proximity sensor, a touch sensor, and/or any additional sensor can be used as opposed to the touch screen to detect a user select one of the predicted inputs or an option to reject all of the predicted inputs. The method is then complete. In other embodiments, the method of FIG. 5 includes additional steps in addition to and/or in lieu of those depicted in FIG. 5.

What is claimed is:

1. A portable computing device comprising:
a sensor to detect a first panel of the portable computing device for a hand gesture at locations of the first panel corresponding to a virtual keyboard;
a touch screen at a second panel of the portable computing device to display at least one predicted input based on the hand gesture; and
a controller to receive an input for the portable computing device in response to a user selecting a predicted input with the touch screen.

2. The portable computing device of claim 1 wherein the first panel includes a rear panel of the portable computing device.

3. The portable computing device of claim 1 wherein the second panel includes a front panel of the portable computing device.

4. The portable computing device of claim 1 wherein the second panel includes a side panel of the portable computing device.

5. The portable computing device of claim 1 wherein the sensor is at least one of a touch screen, a touch sensor, an image capture component, an infrared component, and a proximity sensor.

6. The portable computing device of claim 1 wherein the sensor includes a first portion at the first panel and a second portion at the second panel.

7. The portable computing device of claim 6 wherein the first portion detects for the hand gesture from the user.

8. The portable computing device of claim 6 wherein the second portion detects for the user selecting one of the predicted inputs.

9. The portable computing device of claim 1 further comprising an input component at the second panel to detect the user select the predicted input.

10. A method for detecting an input comprising:
detecting for a hand gesture at locations of a rear panel of a portable computing device with a sensor;
wherein the locations correspond to alphanumeric inputs of a virtual keyboard of the portable computing device;
displaying at least one predicted input at a touch screen included at a front panel of the portable computing device based on the hand gesture; and
receiving an input for the portable computing device in response to detecting a user selecting a predicted input by accessing the touch screen.

11. The method for detecting an input of claim 10 further comprising displaying an option to reject all of the predicted inputs displayed on the touch screen.

12. The method for detecting an input of claim 10 further comprising detecting for a second hand gesture at the rear panel of the portable computing device in parallel with detecting for the hand gesture.

13. The method for detecting an input of claim 10 wherein detecting for a hand gesture includes detecting for fingers at locations of the rear panel corresponding to the virtual keyboard.

14. The method for detecting an input of claim 13 wherein the predicted inputs displayed on the display component include predicted alphanumeric strings which include alphanumeric characters corresponding to accessed locations of the virtual keyboard.

15. The method for detecting an input of claim 14 wherein the user selects one of the predicted alphanumeric strings as an input for the portable computing device.

16. The method for detecting an input of claim 10 wherein detecting for a hand gesture includes detecting for a hand of the user repositioning at the rear panel of the portable computing device.

17. The method for detecting an input of claim 16 wherein the predicted inputs displayed on the display component include predicted navigation commands for the portable computing device.

18. A non-volatile computer readable medium comprising instructions that if executed cause a controller to:
detect a hand gesture at a first panel of a portable computing device;
predict at least one input for the portable computing device based on the hand gesture;
display predicted inputs on a display component included at a second panel of the portable computing device; and
receive an input for the portable computing device in response to detecting a user accessing the second panel to select one of the predicted inputs.

19. The non-volatile computer readable medium of claim 18 wherein the second panel is a removable docking component for the portable computing device.

20. The non-volatile computer readable medium of claim 18 wherein the user uses a thumb to access the second panel and select at least one of a predicted input and an option to reject all of the predicted inputs.
